(19) United States
(12) Patent Application Publication
(10) Pub. No.: US 2023/0320522 A1
(43) Pub. Date: Oct. 12, 2023

(54) DISPOSABLE FOOD PAN LINER

(71) Applicant: DiFranco Innovations, LLC, Kirtland, OH (US)

(72) Inventors: Alessio Adelio DiFranco, Kirtland, OH (US); Jason Tilk, Cleveland Heights, OH (US)

(21) Appl. No.: 17/749,236

(22) Filed: May 20, 2022

Related U.S. Application Data
(60) Provisional application No. 63/328,025, filed on Apr. 6, 2022.

(51) Int. Cl. A47J 36/16; A47J 36/02

(52) U.S. Cl. CPC A47J 36/16; A47J 36/022

(57) ABSTRACT

A disposable food pan liner may have a shape that is complimentary to the food pan into which it is intended to be inserted. The disposable food pan liner may include a base that forms the bottom of the liner, at least one sidewall extending upwards from the base and forming the side of the liner, and an opening opposite the base. A lip may extend outward from the sidewalls at the opening. The disposable food pan liner may include additional elements such as a handle, a utensil rest, a lid, and a reinforcing feature.

### FIELD OF THE INVENTION

The present disclosure relates generally to liners for food service pans, also known as hotel pans.

### BACKGROUND

Food service pans are well-known in the food service industry and can be found in many, if not all, professional kitchens. Also known as hotel pans, these pans can be used for cooking, holding, and storing food. The temperature of the food served from the pans may be maintained by a steam table, ice bath, bain-marie, or other means. The food service pans may be made from a variety of materials, with stainless steel being the most common.

While the food service pans are convenient for preparing, serving, and storing food, they do have drawbacks. Particularly, they must be thoroughly cleaned and disinfected between each use. This can be a time-consuming and costly process depending on the number of pans needed and the types of food held within.

### SUMMARY OF THE INVENTION

An object of this invention is to provide a liner for food service pans that may be disposed or recycled after use in order to reduce labor while retaining the advantages of the pans.

The disposable food pan liner has a shape that is complimentary to the food pan into which it is intended to be inserted. The disposable food pan liner includes a base that forms the bottom of the liner, at least one sidewall extending upwards from the base and forming the side of the liner, and an opening opposite the base. A lip may extend outward from the sidewalls at the opening. When inserted there are generally no gaps between the base, sidewall, and lip of the food pan liner and the food pan.

According to an aspect of the disclosure, a pan liner includes a base, at least one sidewall extending upwardly from the base, an opening opposite the base, a lip extending outwardly from the sidewall at the opening, and a utensil rest, wherein the pan liner's shape is complimentary to the food service pan.

According to an embodiment of any paragraph(s) of this summary, the utensil rest comprise a set of parallel ridges protruding from the at least one sidewall and extending between the base and the opening.

According to an embodiment of any paragraph(s) of this summary, the parallel ridges extend from the base to the opening.

According to an embodiment of any paragraph(s) of this summary, the utensil rest comprises a protrusion extending upwardly from the base and spaced away from the at least one sidewall.

According to an embodiment of any paragraph(s) of this summary, the pan liner includes a lid configured to cover the opening.

According to an embodiment of any paragraph(s) of this summary, the pan liner lid is a snap on lid that mates with the lip.

According to an embodiment of any paragraph(s) of this summary, the pan liner is nestable with other pan liners such that there is a gap between the base of the pan liner and the base of adjacent nested pan liners.

According to an embodiment of any paragraph(s) of this summary, the pan liner maintains its shape when removed from the food service pan.

According to an embodiment of any paragraph(s) of this summary, the pan liner lip comprises a trough about the perimeter of the opening.

According to an aspect of the disclosure, a pan liner includes a base, at least one sidewall extending upwardly from the base, an opening opposite the base, a lip extending outwardly from the sidewall at the opening, and at least one handle extending from the lip, wherein the shape of the pan liner is complimentary to the food service pan such that there are no gaps between the pan liner and the food service pan when the pan liner is inserted into the food service pan.

According to an embodiment of any paragraph(s) of this summary, the pan liner handle comprises a hinged connection with the lip, such that the handle may be folded.

According to an aspect of the disclosure, a pan liner includes a base, at least one sidewall extending upwardly from the base, an opening opposite the base, and a lip extending outwardly from the sidewall at the opening and including a reinforcing feature, wherein the shape of the pan liner is complimentary to the food service pan such that there are no gaps between the pan liner and the food service pan when the pan liner is inserted into the food service pan.

According to an embodiment of any paragraph(s) of this summary, the pan liner lip reinforcing feature is a trough set into the lip about the perimeter of the opening.

While a number of features are described herein with respect to embodiments of the disclosure; features described with respect to a given embodiment also may be employed in connection with other embodiments. The following description and the annexed drawings set forth certain illustrative embodiments of the disclosure. These embodiments are indicative, however, of but a few of the various ways in which the principles of the disclosure may be employed. Other objects, advantages, and novel features according to aspects of the disclosure will become apparent from the following detailed description when considered in conjunction with the drawings.

### BRIEF DESCRIPTION OF THE DRAWINGS

The annexed drawings, which are not necessarily to scale, show various aspects of the disclosure.

FIG. 1 is a food pan liner according to an embodiment of the invention.

FIG. 2 is a food pan liner according to another embodiment of the invention.

FIG. 3 is a food pan liner according to another embodiment of the invention comprising handles.

FIG. 4 is a close-up view of a food pan liner according to another embodiment of the invention comprising folding handles.

FIG. 5 is a food pan liner according to another embodiment of the invention comprising a utensil rest.

FIG. 6 is a food pan liner according to another embodiment of the invention comprising a lid snapped on to the food service pan liner.

FIG. 7 is another view of the embodiment of the food pan liner comprising a lid.

FIG. 8 is a food pan liner according to another embodiment of the invention comprising a reinforcing feature in the lip.

FIG. 9 is a close-up view of the reinforcing feature configured as a trough.

### DETAILED DESCRIPTION

A food service pan liner may possess a shape that is complementary to the food service pan into which it will be inserted such that there is essentially no space between the food service pan and the pan liner. This ensures that heat is transferred through the pan and pan liner to or from the food stored within as desired as well as minimizes a reduction of volume available for food storage. Particulars of various embodiments will be discussed in more detail below.

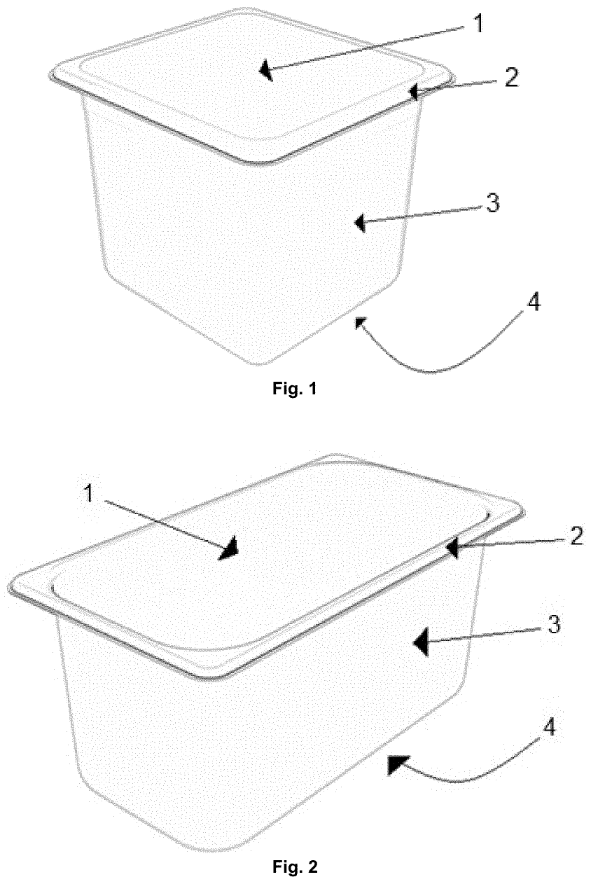

FIG. 1 and FIG. 2 show two exemplary food service pan liners. The food service pan liner may include a base 4 from which at least one sidewall 3 may extend. An opening 1 may be located opposite the base 4. A lip 2 may extend outward from the sidewall 3 at the opening 1. The food service pan liner of FIG. 1 is intended to be inserted into a square-shaped food service pan, while the liner of FIG. 2 is intended to be inserted into a rectangular food service pan. It will be appreciated that the food service pan liner can be made into any number of appropriate shapes to compliment the corresponding food service pan.

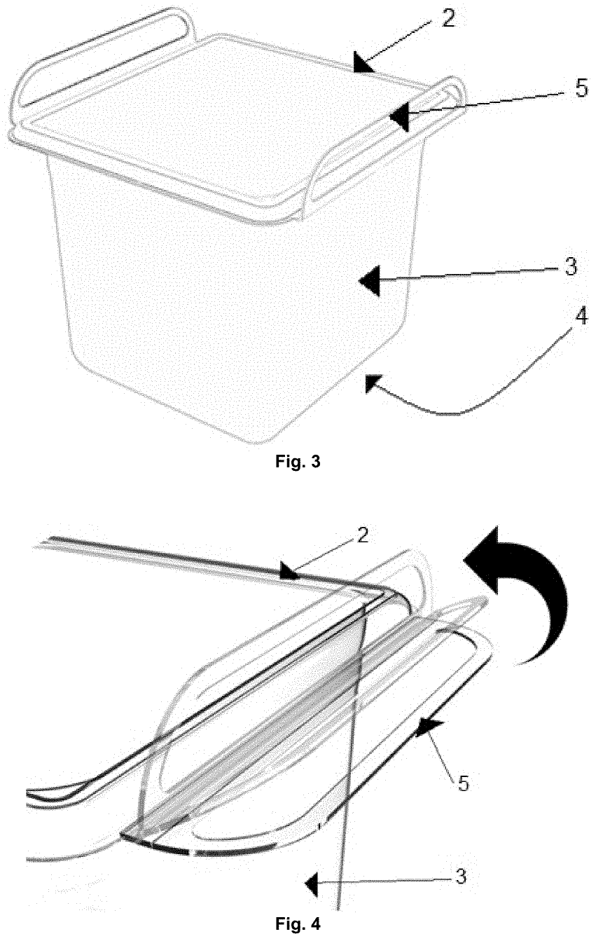

In another embodiment, the food service pan liner may include at least one handle 5 as shown in FIGS. 3 and 4. The handle 5 may extend from the outer edge of the lip 2 and may be hingeably coupled to the lip 2 to fold at the junction of the handle 5 and the lip 2. The handle 5 facilitates insertion and removal of the liner when in the upwards position shown in FIG. 3. The handle 5 may be folded out of the way when the liner is in use, such as for food service.

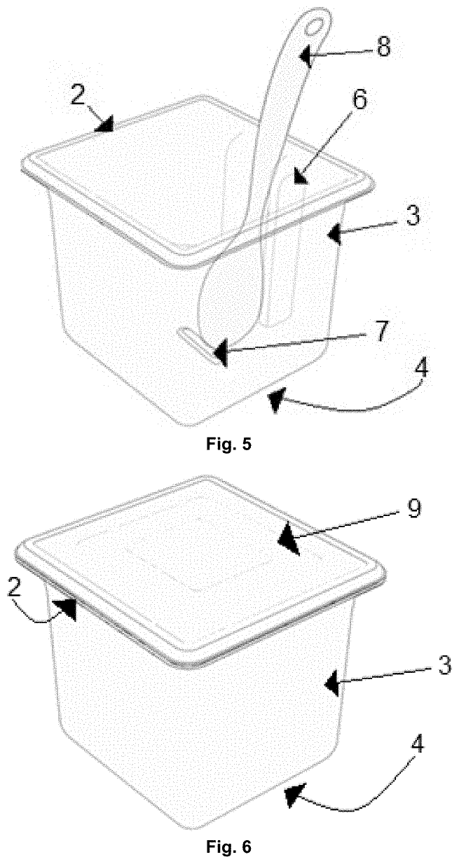

FIG. 5 depicts yet another embodiment where the food service pan liner may include a utensil rest. This feature may keep a utensil 8 generally upright in a convenient location and prevents the utensil 8 from slipping or falling into the food held within the liner.

In one embodiment, the utensil rest may include parallel ridges 6 that protrude inwardly from the sidewall 3 and extend between the base 4 and the lip 2 on the interior side of the sidewall 3. When positioned between the parallel ridges 6, the utensil 8 is prevented from sliding laterally out of the desired position.

In another embodiment, the utensil rest may include a protrusion 7 that extends into the interior of the food service pan liner from the base 4 as shown in FIG. 5. The serving end of the utensil 8 may be rested against the protrusion 7, which prevents the utensil 8 from sliding away from the sidewall 3 and into the food stored within.

In the illustrated embodiment of FIG. 5, the utensil rest includes both the parallel ridges 6 and the protrusion 7.

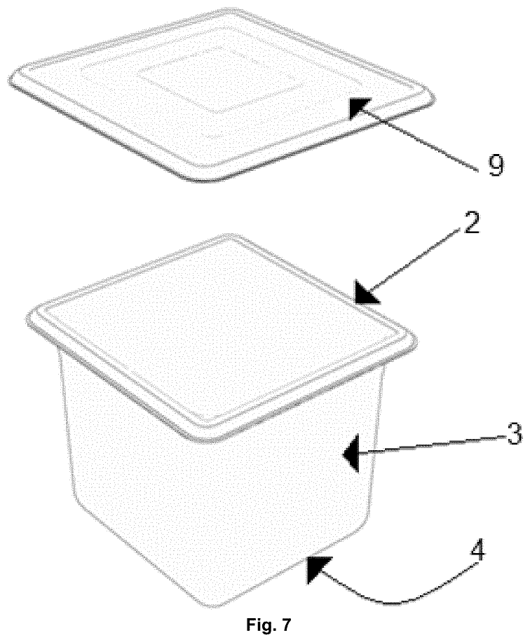

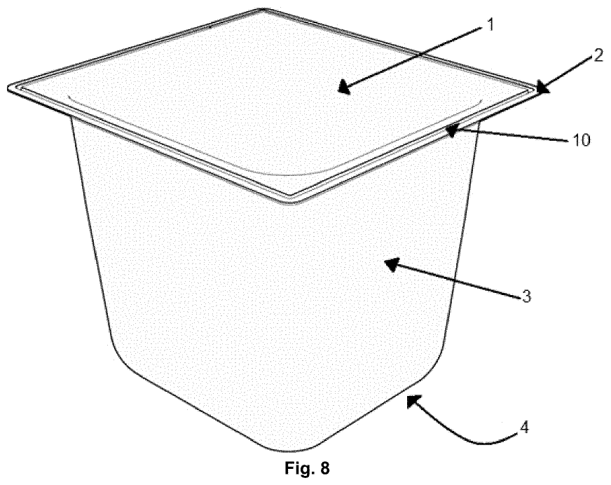

In one embodiment the food service pan liner may include a lid 9 as shown in FIGS. 6 and 7. The lid 9 may be of a snap on type that securely mates with the lip 2. The lid 9 allows food to be stored within the liner before it is served. Additionally, the lid 9 may help keep the food fresh and prevent debris from falling into the liner.

An object of this invention is to provide a pan liner that may be disposed or recycled after use in order to reduce labor while minimizing the environmental impact. Another criteria may be for heat to transfer relatively efficiently through the liner from the food to the pan or viceversa. To meet this criteria, the liner may be manufactured, for example, by a process of extrusion blow-molding (EBM) of PET (polyethylene) or HDPE (high-density polyethylene) or by vacuum or thermal forming of polypropylene (PP) potentially with an additive high-melt-strength polypropylene (HMS-PP), crystalized polylactic acid (CPLA), or Polyetherimide (PEI). The liner may be manufactured in various different wall thickness such as, for example, thickness between 0.010″ to 0.075″ (0.25 mm to 1.9 mm). In other embodiments, the liner may be manufactured by other processes, from other materials, and having other thicknesses. In one embodiment, the food service pan liner is manufactured having sufficient wall thickness and/or having reinforcing features so that the liner may stand freely on its own.

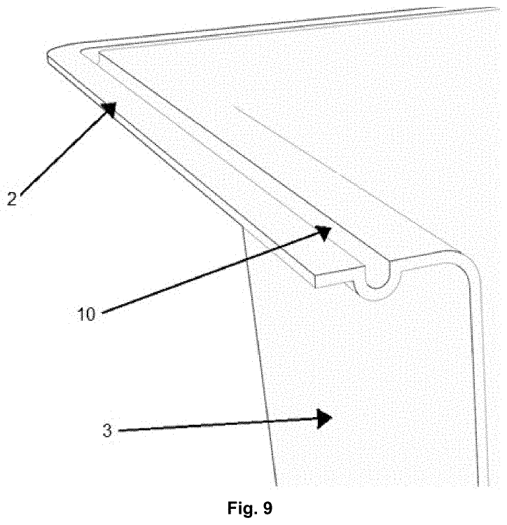

In one embodiment the food service pan liner may include a reinforcing feature 10 formed in the lip 2 as shown in FIGS. 8 and 9. The reinforcing feature 10 may provide rigidity to the food pan liner, making it stronger and allowing it to better maintain its shape. The reinforcing feature 10 may be in the form of a trough set in the lip 2 about the perimeter of the opening 1. The trough configuration may also simplify production by maintaining the flat upper plane of the lip 2, which in turn allows easier shaping and cutting of the food service pan liner. In an alternative embodiment, the trough may instead extend upwards from the lip 2. As shown in FIG. 9, the trough 10 may have a semicircular or semioval cross-section. In other embodiments, the trough 10 may have a cross-sections different from semicircular or semioval cross-section (e.g., square, rectangular, triangular, etc.)

Although the disclosure has been shown and described with respect to a certain embodiment or embodiments, equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the disclosure. In addition, while a particular feature of the disclosure may have been described above with respect to only one or more of several illustrated embodiments, such feature may be combined with one or more other features of the other embodiments, as may be desired and advantageous for any given or particular application.

### LIST OF REFERENCE NUMERALS

1 . . . Opening
2 . . . Lip
3 . . . Sidewall
4 . . . Base
5 . . . Handle
6 . . . Utensil rest: parallel ridges
7 . . . Utensil rest: protrusion
8 . . . Utensil
9 . . . Lid
10 . . . Reinforcing feature

1. A pan liner configured to be inserted into a food service pan, comprising:
a base;
at least one sidewall extending upwardly from the base;
an opening opposite the base;
a lip extending outwardly from the sidewall at the opening; and
a utensil rest;
wherein a shape of the pan liner is complimentary to the food service pan; and
wherein the pan liner maintains its shape when removed from the food service pan.

2. The pan liner of claim 1, wherein the utensil rest comprises a set of parallel ridges protruding inwardly from the at least one sidewall, the parallel ridges extending between the base and the opening.

3. The pan liner of claim 1, the parallel ridges extending from the base to the opening.

4. The pan liner of claim 1, wherein the utensil rest comprises a protrusion extending upwardly from the base and spaced away from the at least one sidewall.

5. The pan liner of claim 2, wherein the utensil rest further comprises a protrusion extending upwardly from the base and spaced away from the at least one sidewall.

6. The pan liner of claim 1, comprising a lid configured to cover the opening.

7. The pan liner of claim 6, wherein the lid is a snap on lid that mates with the lip.

8. The pan liner of claim 1, wherein the pan liner is nestable with another pan liner.

9. The pan liner of claim 1, wherein the lip comprises a trough about a perimeter of the opening.

10. A pan liner configured to be inserted into a food service pan, comprising:
a base;
at least one sidewall extending upwardly from the base;
an opening opposite the base;
a lip extending outwardly from the sidewall at the opening; and
at least one handle extending from the lip;
wherein a shape of the pan liner is complimentary to the food service pan;
wherein the pan liner maintains its shape when removed from the food service pan; and
wherein the handle comprises a hinged connection with the lip such that the handle may be folded.

11. The pan liner of claim 10 comprising a lid configured to cover the opening.

12. The pan liner of claim 11, wherein the lid is a snap on lid that mates with the lip.

13. The pan liner of claim 10, further comprising a utensil rest comprising a set of parallel ridges protruding inwardly from the at least one sidewall, the parallel ridges extending between the base and the opening.

14. The pan liner of claim 13, the parallel ridges extending from the base to the opening.

15. The pan liner of claim 10, further comprising a utensil rest comprising a protrusion extending upwardly from the base and spaced away from the at least one sidewall.

16. The pan liner of any of claim 10, wherein the pan liner is nestable with another pan liner.

17. The pan liner of claim 10, wherein the lip comprises a trough about a perimeter of the opening.

18. A pan liner configured to be inserted into a food service pan, comprising:
a base;
at least one sidewall extending upwardly from the base;
an opening opposite the base; and
a lip extending outwardly from the sidewall at the opening;
wherein the shape of the pan liner is complimentary to the food service pan;
wherein the pan liner maintains its shape when removed from the food service pan; and
wherein the lip has formed thereon a trough disposed around a perimeter of the opening.

19. The pan liner of claim 18, further comprising a utensil rest.

20. The pan liner of claim 19, wherein the utensil rest comprises a set of parallel ridges protruding inwardly from the at least one sidewall, the parallel ridges extending between the base and the opening.

21. The pan liner of claim 20, the parallel ridges extending from the base to the opening.

22. The pan liner of claim 19, wherein the utensil rest comprises a protrusion extending upwardly from the base and spaced away from the at least one sidewall.

23. The pan liner of claim 18, comprising a lid configured to cover the opening.

24. The pan liner of claim 23, wherein the lid is a snap on lid that mates with the lip.

25. The pan liner of claim 18, wherein the pan liner is nestable with another pan liner.

26. The pan liner of claim 18, further comprising at least one handle extending from the lip.
